(19) United States
(12) Patent Application Publication
(10) Pub. No.: US 2023/0193692 A1
(43) Pub. Date: Jun. 22, 2023

(54) SAFETY APPARATUS FOR PASSENGERS OR PEDESTRIANS

(71) Applicant: SKD HI-TEC CO., LTD., Gwangyang-si, Jeollanam-do (KR)

(72) Inventor: Sung Moo HAN, Yeosu-si, Jeollanam-do (KR)

(73) Assignee: SKD HI-TEC CO., LTD., Gwangyang-si, Jeollanam-do (KR)

(21) Appl. No.: 17/925,841

(22) PCT Filed: Sep. 28, 2020
(86) PCT No.: PCT/KR2020/013257

§ 371 Date: Nov. 17, 2022

(30) Foreign Application Priority Data
Jul. 21, 2020 (KR) 10-2020-0090607

(51) Int. Cl. E06B 11/02; E05F 15/00

(52) U.S. Cl. CPC E06B 11/025; E05F 15/00; E05Y 2201/43; E05Y 2201/684; E05Y 2201/688; E05Y 2900/40

(57) ABSTRACT

Proposed is a safety apparatus using blocking members, such as rope, for allowing or blocking passage of passengers and pedestrians. The safety apparatus of the present disclosure is configured to reduce a vertical distance of the blocking members when the vertically arranged blocking members are raised to allow passage and increase the vertical distance of the blocking members when the blocking members are lowered to block the passage and reduce a vertical length of the apparatus.

### TECHNICAL FIELD

An embodiment of the present disclosure relates to a traffic safety apparatus. In detail, the embodiment of the present disclosure relates to the safety apparatus using blocking members, such as rope, to allow or block passage of passengers and pedestrians.

### BACKGROUND ART

In general, safety devices for passengers and pedestrians are installed at both ends of a platform or crosswalk to prevent safety accidents of passengers and pedestrians.

However, in the related arts, since blocking members for blocking passage of passengers and pedestrians are arranged and fixed to be spaced apart from each other by a predetermined distance in a vertical direction when viewed from the front, in order to move the blocking members in the vertical direction, components must be manufactured unnecessarily high, resulting in a problem that the safety device cannot be applied to a location or space where an installation space is not large.

In particular, when the height of the components rises, a wobble occurs in a process of moving the blocking members in the vertical direction, thereby weakening safety, and causing malfunctions and frequent failures.

In addition, in the related arts, the blocking members are rotated in the horizontal or vertical direction to allow or block the passage of passengers and pedestrians. However, while blocking members having a large area rotate in the vertical or horizontal direction, the blocking members might cause interference and collision with peripheral facilities.

As the related art, Korean Utility Model Registration No. 20-0400235 (Nov. 4, 2005), Korean Patent No. 10-0601112 (Jul. 19, 2006), Korean Patent No. 10-0722868 (May 30, 2007), Korean Patent No. 10-1143843 (May 4, 2012), Korean Patent Application Publication No. 10-2014-0007980 (Jan. 20, 2014), Korean Patent Application Publication No. 10-2014-0009813 (Jan. 23, 2014), Korean Patent No. 10-1471543 (Dec. 11, 2014), Korean Patent Application Publication No. 10-2015-0013410 (Feb. 5, 2015), Korean Patent Application Publication No. 10-2015-0013411 (Feb. 5, 2015), and Korean Patent No. 10-2088513 (Mar. 12, 2020) may be referred thereto. In addition, Japanese Patent Application Publication No. 2008-534827 (Aug. 28, 2008) may be referred thereto.

### DISCLOSURE

### Technical Problem

An embodiment of the present disclosure is to provide a safety apparatus for passengers and pedestrians by reducing a vertical distance of blocking members when the blocking members are raised to allow passage of passengers and pedestrians and increasing the vertical distance of blocking members when the blocking members are descended to block the passage of passengers and pedestrians.

An embodiment of the present disclosure is to provide the safety apparatus capable of reducing the vertical distance of the blocking members by raising the lowermost blocking member and lifting the remaining blocking members sequentially.

An embodiment of the present disclosure is to provide the safety apparatus capable of limiting a descent of the uppermost blocking member at a set position and further lowering the remaining blocking members to increase the vertical distance between the blocking members.

### Technical Solution

According to an embodiment of the present disclosure, a safety apparatus for passengers and pedestrians including a pair of main bodies 110 installed on both sides of a specified location, a plurality of movable units 120 configured to be movable in a vertical direction on an inside or one side of the main body 110, a blocking member 200 configured to connect the movable units 120 facing each other in a horizontal direction on both opposite end, a connecting member 130 forming a connection between the plurality of movable units 120, a driving unit 140 connected to a lowermost movable unit 120 among the plurality of movable units 120, and configured to sequentially lift the remaining movable units 120 when the lowermost movable unit 120 is raised to reduce a vertical distance between the movable units 120, and a stop unit 150 configured to fix a uppermost movable unit 120 on one side of the main body 110 among the plurality of movable units 120, descending by an operation of the driving unit 140 and its own weight, to enlarge the vertical distance between the movable units 120 while the remaining movable units 120 are sequentially descended may be provided.

Each of the movable unit 120 may include a roller 121 configured to be movable in the vertical direction along two rails 111 and 112, the two rails (111) and (112) being provided in an inside of the main body 110 and spaced apart from front and rear at a predetermined distance, when viewed in a planar state, a movable body 122 coupled to the roller 121 at one end thereof, and a connector 123 provided on an opposite side of the movable body 122 and configured to be coupled to one end of the blocking member 200.

The driving unit 140 may include a pair of rotatable bodies 141 provided on upper and lower portions of the main body 110, a driving motor 142 provided on one side of the rotatable bodies 141, a connecting body 143 configured to movably pass over the rotatable body 141, and a coupler 144 configured to be connected to the lowermost movable unit 120 among the plurality of movable units 120 on one side of the connecting body 143.

The stop unit 150 may include a stopping member 151 provided on one end of the uppermost movable unit 120 among the plurality of movable units 120, a height adjustment rail 152 provided on one side of the main body 110 in the vertical direction, and a support member 153 configured to be in contact with the stopping member 151 by moving and fixing it in the vertical direction along the height adjustment rail 152.

### Advantageous Effects

According to an embodiment of the present disclosure, the present disclosure may allow or block passage of passengers and pedestrians by reducing or expanding a vertical distance of a blocking members. In addition, the present disclosure may prevent safety accidents in advance by adjusting the height to block the passage of passengers and pedestrians. In addition, the present disclosure can be easily applied to a place or location with a small installation space by minimizing a height of a main body.

### DESCRIPTION OF DRAWINGS

FIG. 1 is a front view showing a configuration of a safety apparatus according to an embodiment of the present disclosure.

FIG. 2 is a plan view showing a configuration of a safety apparatus according to an embodiment of the present disclosure.

FIG. 3 is a side view showing a configuration of a safety apparatus according to an embodiment of the present disclosure.

FIG. 4 is a front view showing a configuration of a safety apparatus according to an embodiment of the present disclosure.

### MODE FOR INVENTION

Herein below, preferred embodiments of the present invention will be described in detail with reference to the accompanying drawings.

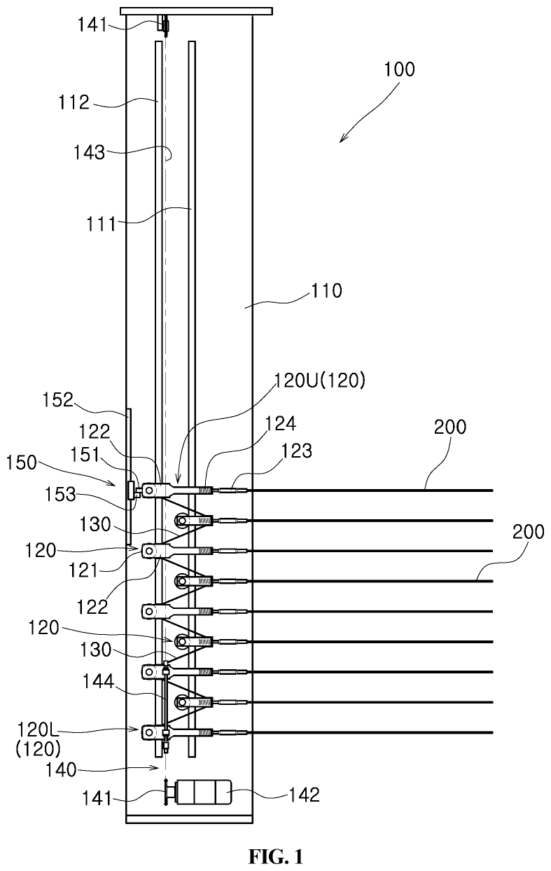

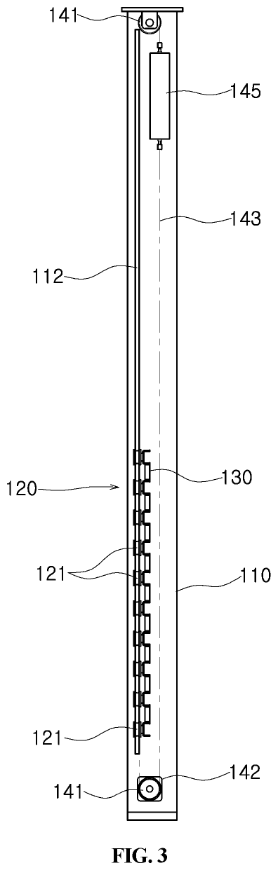

The safety apparatus according to an embodiment of the present disclosure may be installed on a platform or installed on at least one of both ends of a crosswalk to allow or block passage of passengers and pedestrians to prevent safety accidents of passengers and pedestrians. A configuration and operation of the safety apparatus according to the embodiment of the present disclosure are shown in FIGS. 1 to 4.

With reference to FIGS. 1 to 4, the safety apparatus according to the embodiment of the present disclosure may include a pair of main bodies 110 installed on both sides of a specified location, a plurality of movable units 120 configured to be movable in a vertical direction on an inside or one side of the main body 110, a blocking member 200 configured to connect the movable units 120 facing each other in a horizontal direction on both opposite end, a connecting member 130 forming a connection between the plurality of movable units 120, a driving unit 140 connected to a lowermost movable unit 120 among the plurality of movable units 120, and configured to sequentially lift the remaining movable units 120 when the lowermost movable unit 120 is raised to reduce a vertical distance between the movable units 120, and a stop unit 150 configured to fix an uppermost movable unit 120 on one side of the main body 110 among the plurality of movable units 120, descending by an operation of the driving unit 140 and its own weight, to enlarge the vertical distance between the movable units 120 while the remaining movable units 120 are sequentially descended.

At here, when the lowermost movable unit 120 is raised by the driving unit 140, the remaining movable units 120 positioned above the lowermost movable unit 120 are sequentially lifted by the lowermost movable unit 120, and the vertical distance of the movable units 120 on both sides is reduced, resulting in a reduce of the vertical distance between the blocking members 200, accordingly.

Conversely, when the lowermost movable unit 120 is descended by the driving unit 140, the remaining upper movable units 120, lifted by the lowermost movable unit 120, is lowered by its own weight. At the moment, the uppermost movable unit 120 is restricted from descending due to the stop unit 150 at a certain height, while the remaining movable units 120 positioned below the uppermost movable unit 120 can be further descended. Therefore, when the movable units 120 on both sides are lowered, the vertical distance is increased, and the vertical distance of the blocking members 200 may also be increased, thereby. Of course, the descending limiting position of the uppermost movable unit 120 by the stop unit 150 is the height at which the vertical distance between the reduced movable units 120 are enlarged when the lowermost movable unit 120 is lowered by the driving unit 140.

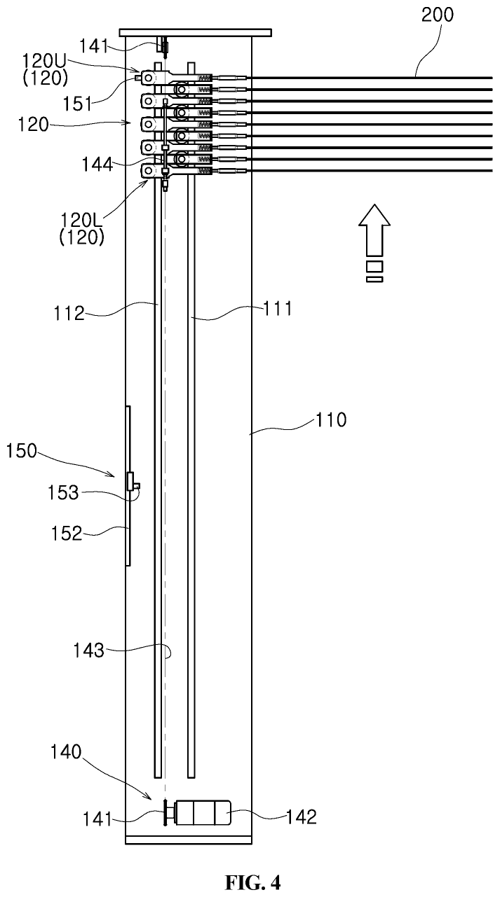

The safety apparatus according to the embodiment of the present disclosure as described above, when the movable units 120 on both sides are raised together with the blocking members 200, the passage of passengers and pedestrians may be allowed by the reduced vertical distance of the blocking members 200 (refer to FIG. 4), and when the movable units 120 on both sides are descended together with the blocking members 200, the passage of passengers and pedestrians may be blocked by the enlarged vertical distance of the blocking members 200 (refer to FIG. 1). At the moment, according to the configuration in which the vertical distance of the blocking members 200 is reduced when the movable units 120 on both sides are raised, the lifting distance between the movable units 120 and the blocking members 200 on both sides may be reduced. In addition, according to the configuration in which the vertical distance of the blocking members 200 is enlarged when the movable units 120 on both sides are descended, the passage blocking area for passengers and pedestrians may be secured to an elevated height.

The pair of main bodies 110 may be elongated in the vertical direction. The pair of main bodies 110 may be erected to face each other on both left and right sides (both sides based on the longitudinal direction of a platform) at a designated position on the platform, on both sides of the left and right (both sides based on the width direction of the crosswalk) at a designated position at the end of the crosswalk. For reference, FIGS. 1 and 4 show the safety apparatus according to the embodiment of the present disclosure with respect to any one of the pair of main bodies 110.

As shown in FIG. 1, each of the pair of main bodies 110 is provided with movement guide rails 111 and 112 in the vertical direction. Each of the main bodies 110 may have an inner space, and the movement guide rails 111 and 112 may be disposed in the inner space of each main body 110. The movement guide rails 111 and 112 induce the movable units 120 on both sides to sequentially move in the vertical direction.

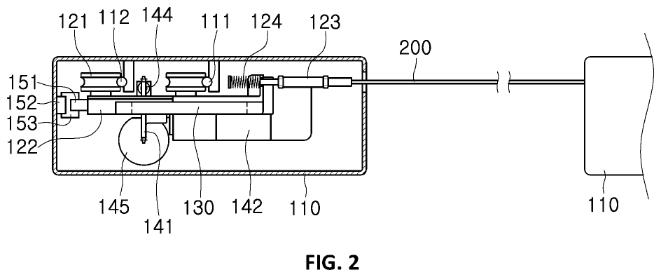

Each of the movement guide rails 111 and 112 may be composed of first rail 111 and second rail 112 disposed at a predetermined interval so as to be spaced apart from each other left and right when viewed from above (refer to FIG. 2). In addition, when viewed from the front (refer to FIG. 1), some of the movable units 120 may configured to be move in the vertical direction along the first rail 111 and the rest may configured to be moved in the vertical direction along the second rail 112. For example, as shown in FIG. 1, the movable units 120 may alternately move along the first rail 111 and the second rail 112. With this configuration, as the movable unit 120 moving along the first rail 111 and the movable unit 120 moving along the second rail 112 alternate, the vertical distance between the blocking members 200 may be reduced.

The first rail 111 and the second rail 112 may be disposed on a straight line on the left and right, and the movable units 120 and the blocking member 200 on both sides may be disposed vertically, on a straight line, respectively. Thereby, the volume can be minimized, and the movable units 120 and the blocking members 200 on both sides can be smoothly moved up and down even in a small space to allow or block the passage of passengers and pedestrians.

Each of the movable units 120 on both sides include a roller 121 moving in the vertical direction along the movement guide rails 111 and 112, a movable body 122 in which the roller 121 is rotatably supported on one side, and a connector 123 for connecting one end of the blocking member 200 to the opposite side of the movable body 122, respectively.

At least one of the connectors 123 may have a right-hand thread formed on one side of the connector 123 and a left-hand thread formed on the opposite side with respect to the middle, so that a tension of the blocking member 200 can be adjusted according to a rotating direction. To this end, a turnbuckle may be applied as the connector 123.

Each of the movable units 120 on both sides further includes an elastic body 124 interposed between the movable body 122 and the connector 123, respectively, so that the tension of the blocking members 200 can be maintained at a certain level or more by the elastic force of the elastic bodies 124. A spring or the like may be applied as the elastic body 124.

The connecting members 130 on both sides respectively connect between the movable units 120 on one side and between the movable units 120 on the other side, so that when the lowermost movable unit 120 is descended by the driving unit 140, the connecting member 130 can guide the remaining movable unit 120 positioned above the lowermost movable unit 120 to be surely descend. For example, even if the upper movable unit 120 does not descend smoothly, the upper movable unit 120 that does not descend smoothly is connected to the lower movable unit 120 and the connecting member 130 by the connecting member 130, so that the upper movable unit 120 that is not descended smoothly to be surely descended.

Both of these connecting members 130 may be configured to have flexibility to flexibly respond to a change in the vertical distance of the movable units 120 on both sides. For example, the connecting members 130 on both sides may be made of a soft material such as synthetic resin or rubber.

Two driving units 140 may be provided to move the lowermost movable unit 120 on both sides in the vertical direction, respectively, or only one driving unit 140 may be provided to move one of the lowermost movable units 120 in the vertical direction. The driving unit 140 includes a pair of rotatable bodies 141 provided in both upper and lower sides of the main body 110, a driving motor 142 for rotating any one of the rotatable bodies 141, a connecting body 143 configured to move while passing over the pair of rotatable bodies 141, and a coupler 144 configured to connect the connecting body 143 with the lowermost movable unit 120. According to this, the lowermost movable unit 120 is raised or lowered in accordance with the moving direction of the connecting body 143.

The driving unit 140 may further include a speed reducer for reducing a rotational speed provided to the rotational body 141, thereby smoothly rotating the pair of rotatable bodies 141. A sprocket wheel, a belt pulley, etc. may be applied as the pair of rotatable bodies 141, and a chain, a belt, etc. may be applied as the connecting body 143. The pair of rotatable bodies 141 may be disposed above and below the section in which the movable units 120 vertically move.

As the driving unit 140, various other means such as a cylinder or a combination of a screw jack and a motor for moving the lowermost movable unit 120 in the vertical direction, may be applied differently as described above.

On the other hand, the driving unit 140 may be operated automatically to allow or block the passage of passengers and pedestrians by interlocking with a control unit of an existing train (subway) or traffic light, or selectively through an operation of a separate manual button.

The stop unit 150 limits the descent of the uppermost movable unit 120 to a predetermined height when both movable units 120 are lowered by the driving unit 140, so that the vertical distance of both movable units 120 are enlarged, thereby enlarging the vertical distance of the blocking members 200.

Although the descent of the uppermost movable unit 120 is limited by the stop unit 150, the lowermost movable unit 120 may be further descended by the driving unit 140. At here, if at least one or more movable units 120 are disposed between the uppermost and lowermost movable units 120, the movable units 120 between the uppermost and lowermost movable units 120 can be also descended further by its own weight.

The stop unit 150 includes a height adjustment rail 152 provided in a vertical direction on one pair or one of the pair of the main body 110, a support member 153 capable of moving in the vertical direction along the height adjustment rail 152 and having a position fixed at a predetermined height by a position fixing mechanism, a stop member 151 provided in the uppermost movable unit 120 and configured to limit the descending position of the uppermost movable unit 120 by contacting the support member 153 when the uppermost movable unit 120 is descended.

The stop member 151 protrudes from the uppermost movable unit 120 so that the uppermost movable unit 120 is configured in which the lower side contacts the upper side of the support member 153 when the uppermost movable unit 120 is lowered, thereby preventing interference with the support member 153 when the uppermost movable unit 120 is raised. When the position fixing of the position fixing mechanism with respect to the support member 153 is released, after moving the support member 153 vertically, and the position of the moved support member 153 is fixed again by the position fixing mechanism, the height of the support member 153 is changed. By adjusting the height of the support member 153, the vertical distance between the movable units 120 on both sides can be adjusted while changing descending position of uppermost movable unit 120.

With the configuration that maintains the tension of the blocking members 200 by the connectors 123 or the elastic bodies 124, even if only one of the uppermost movable units 120 of both sides is limited to descent by the stop unit 150, the descent of both uppermost movable units 120 can be actively restricted.

The blocking members 200 are for allowing or blocking the passage of passengers and pedestrians, and a material of the blocking members 200 may be hard or soft that can minimize safety accidents caused by collisions with passengers or guardians. As an example, the blocking members 200 may be flexible ropes. As another example, the blocking members 200 may be coated with rubber, synthetic resin, etc. in order to prevent damage (corrosion, etc.) of the rope and/or provide buffering properties to the rigid rope.

Reference numeral 145, which is not described above, denotes a weight, and the weight 145 may be connected to a moving connecting body 143.

1. A safety apparatus for passengers and pedestrians, the safety apparatus comprising:
a pair of main bodies (110) installed on both sides of a specified location;
a plurality of movable units (120) configured to be movable in a vertical direction in an inside therein in each of the pair of main bodies (110) or one side of the main body (110);
a plurality of blocking members (200) connecting a corresponding movable unit of the plurality of movable units (120) in a first main body of the pair of main bodies (110) to a corresponding movable unit of the plurality of movable units (120) in a second main body of the pair of main bodies (110);
a connecting member (130) forming a connection between the plurality of movable units (120) in each of the pair of main bodies (110);
a driving unit (140) connected to the lowermost movable unit (120) among the plurality of movable units (120), and configured to sequentially lift the remaining movable units (120) to reduce a vertical distance between neighboring movable units among the plurality of movable units when the lowermost movable unit (120) is raised; and
a stop unit (150) configured to fix an uppermost movable unit (120) on one side of the main body (110) among the plurality of movable units (120), descending by an operation of the driving unit (140) and its own weight, to increase the vertical distance between the movable units (120) while the remaining movable units (120) are sequentially descended.

2. The safety apparatus for passengers and pedestrians of claim 1,
wherein each of the movable units (120) comprises:
a roller (121) configured to be movable in the vertical direction along two rails (111) and (112), the two rails (111) and (112) being provided in an inside of the main body (110) and spaced apart from front and rear at a predetermined distance, when viewed in a planar state;
a movable body (122) coupled to the roller (121) at one end thereof; and
a connector (123) provided on an opposite side of the movable body (122) and configured to be coupled to one end of the blocking member (200).

3. The safety apparatus for passengers and pedestrians of claim 1,
wherein the driving unit (140) comprises:
a pair of rotatable bodies (141) provided on upper and lower portions of the main body (110);
a driving motor (142) provided on one side of the rotatable bodies (141);
a connecting body (143) configured to movably pass over the rotatable bodies (141); and
a coupler (144) configured to be connected to the lowermost movable unit (120) among the plurality of movable units (120) on one side of the connecting body (143).

4. The safety apparatus for passengers and pedestrians of claim 1,
wherein the stop unit (150) comprises:
a stopping member (151) provided on one end of the uppermost movable unit (120) among the plurality of movable units (120);
a height adjustment rail (152) provided on one side of the main body (110) in the vertical direction; and
a support member (153) configured to be in contact with the stopping member (151) by moving and fixing it in the vertical direction along the height adjustment rail (152).
